(19) United States
(12) Patent Application Publication
(10) Pub. No.: US 2005/0051217 A1
(43) Pub. Date: Mar. 10, 2005

(54) Valve

(76) Inventor: Oliver Bastien, Ogden, UT (US)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/659,768

(22) Filed: Sep. 10, 2003

(51) Int. Cl. F16K 17/04

(52) U.S. Cl. 137/538

(57) ABSTRACT

A valve is disclosed for an air-bag for use as a safety device in a motor vehicle. The valve comprises a fixed component (1) which has a mount such as a mounting flange (2) for mounting the fixed component (1) to an air-bag or gas generator housing. The fixed component (1) defines at least one aperture (5). The valve also incorporates a moveable component (6) which is configured to be slidingly engaged with the fixed component and which has at least one other aperture (11) formed therein. The two components (1), (6) have an initial position in which the aperture (5) in the fixed component is off-set from the or each aperture (11) in the moveable component. The moveable component is moveable relative to the fixed component to a position in which at least part of the or each aperture (11) formed in the moveable component (6) is co-aligned with the aperture (5) in the fixed component (1) so as to create a vent flow passage for gas from the interior of the air-bag or gas generator housing.

THE PRESENT INVENTION relates to a valve and more particularly relates to a valve for use with an air-bag.

It is known that, for many air-bags used as safety devices within motor vehicles, it is of great importance to vent the air-bag when a vehicle occupant to be restrained by the air-bag is in the process of impacting with the air-bag. If the air-bag is not vented at this stage of an accident situation, the pressure of gas within the air-bag can rise extremely rapidly, as the air-bag is effectively compressed, so that the internal volume of the air-bag is reduced, by the body of the occupant of the seat, who may be impacting with the air-bag with substantial velocity, and thus with substantial energy.

On the other hand, it is desired to be able to inflate an air-bag relatively swiftly in an accident situation, and if an air-bag is provided with a permanently open vent, gas from the gas generator or inflator will escape through that vent before the air-bag is fully inflated. This is undesirable.

It has now been found that it may be advantageous to vent an air-bag in a “variable” manner. The degree of venting provided within an air-bag, in a typical present-day situation, is solely determined by the area of the venting aperture.

Consequently it has now been found to be appropriate to consider providing an aperture which has an area which is variable in dependence upon certain parameters. Consequently the area of the vent may be adjusted, so that the cushioning effect provided by the air-bag is suited, in an optimum manner, to the circumstances of the particular accident.

The present invention seeks to provide an improved valve for use with an air-bag.

According to the present invention, there is provided a valve for an air-bag, the valve comprising a fixed component, the fixed component having a mount to mount the component to an air-bag or a gas generator housing, the fixed component defining at least one aperture, the valve incorporating a moveable component configured to be exposed to pressure from inflating gas within the air-bag, the moveable component also being configured to be slidably engaged with the fixed component and having at least one aperture formed therein, the components having an initial position in which the aperture in the fixed component is totally off-set from the or each aperture in the movable component, and the moveable component being moveable relative to the fixed component, under the action of gas pressure within the air-bag to a position in which at least part of the or each aperture formed in the movable component is co-aligned with the aperture in the fixed component thus creating a vent flow passage for gas from the interior of the air-bag or the gas generator housing.

Preferably the valve is provided mounted on an air-bag or a gas generator housing.

Advantageously, the fixed component comprises a tubular housing, the or each aperture of the fixed component being formed in a side-wall of the tubular housing.

Conveniently, the tubular housing is provided with a flange at one end to act as said mount.

Preferably, the moveable component comprises a cylindrical housing, the cylindrical housing being configured to be received as a sliding and substantially sealing fit within the tubular housing of the fixed component, there being an element to maintain the moveable component in said initial position relative to the fixed component.

Advantageously, the or each aperture of the movable component is formed within the side-wall of the cylindrical housing.

Conveniently, the element to maintain the movable component in said initial position relative to the fixed component is a spring, the spring surrounding the cylindrical housing of the movable component and being engaged by a flange carried on the movable component and the mount of the fixed component.

Preferably, the movable component is provided with one or more deformable elements which engage part of the fixed component to hold the movable component in said initial position relative to the fixed component, the or each deformable element being configured to deform when gas pressure is applied to the movable component to permit the movable component to move relative to the fixed component.

Advantageously, the fixed component has a single aperture.

Conveniently, the fixed component has a plurality of apertures.

Preferably, the or each aperture of the moveable component is of rectangular form.

Advantageously, the or each aperture of the moveable component is of triangular form.

Conveniently, the or each aperture of the moveable element is of irregular form.

Preferably, the movable component is moved relative to the fixed component in response to a signal representative of a parameter.

Conveniently, the parameter relates to the weight of a seat occupant.

Alternatively, the parameter relates to an indicator of accident severity.

In order that the invention may be more readily understood, and so that further features thereof may be appreciated, embodiments of the invention will now be described, by way of example, with reference to the accompanying drawings in which:

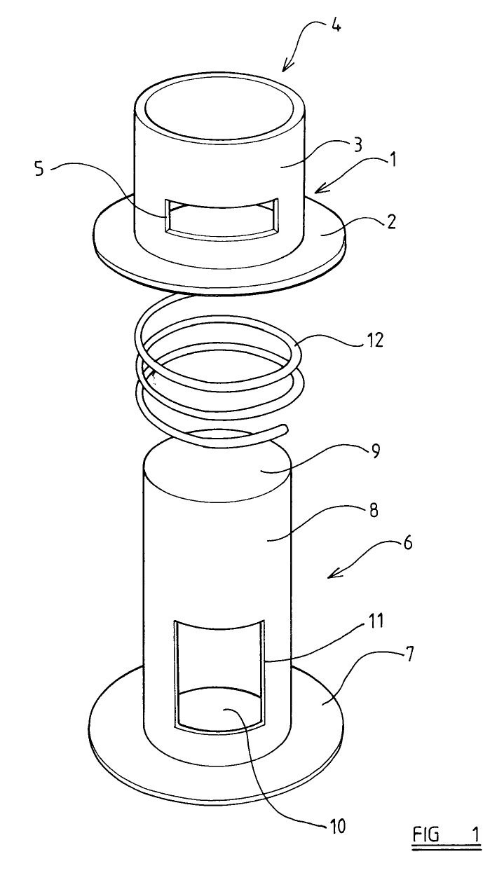

FIG. 1 is an exploded view of the principal components of one valve in accordance with the invention,

FIG. 2 is a view of the components of the valve of FIG. 1 assembled, showing the components in a first relative position,

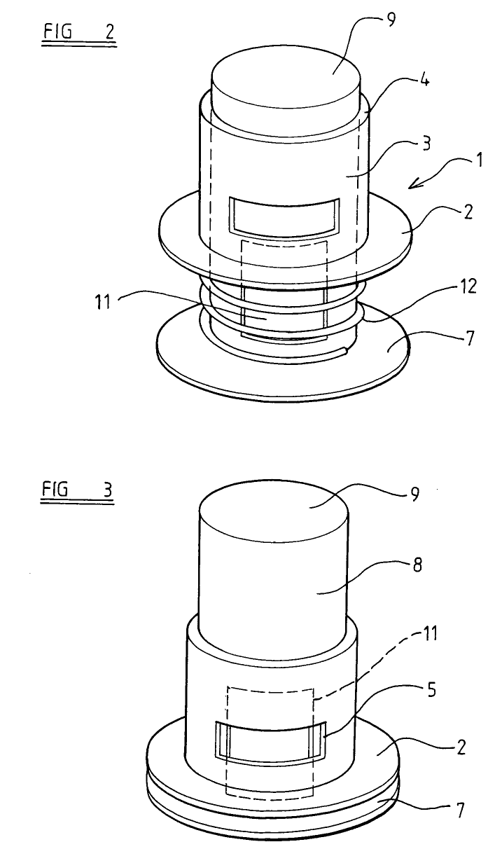

FIG. 3 is a view corresponding to FIG. 2 showing the components of the valve in a second relative position,

FIG. 4 is a view of a modified component which may be used with a valve equivalent to that of FIGS. 1 to 3,

FIG. 5 is a diagrammatic view illustrating the position of two components of a valve, one of the components being the component of FIG. 4,

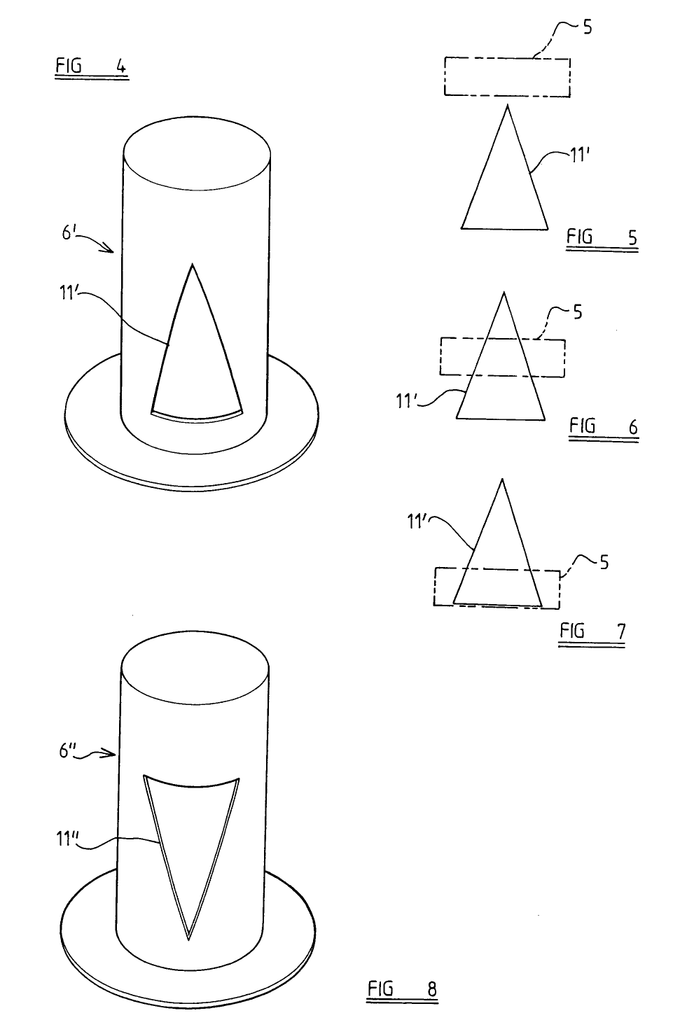

FIG. 6 is a view corresponding to FIG. 5 showing a subsequent position of the two components,

FIG. 7 is a view corresponding to FIG. 5 showing the final position of the two components,

FIG. 8 is a view of a further modified component, similar to that of FIG. 4, intended for use in a valve equivalent to that of FIGS. 1 to 3,

FIG. 9 illustrates a further form of aperture which may be utilised in an embodiment of the invention,

FIG. 10 illustrates yet another form of aperture which may be used in an embodiment of the invention,

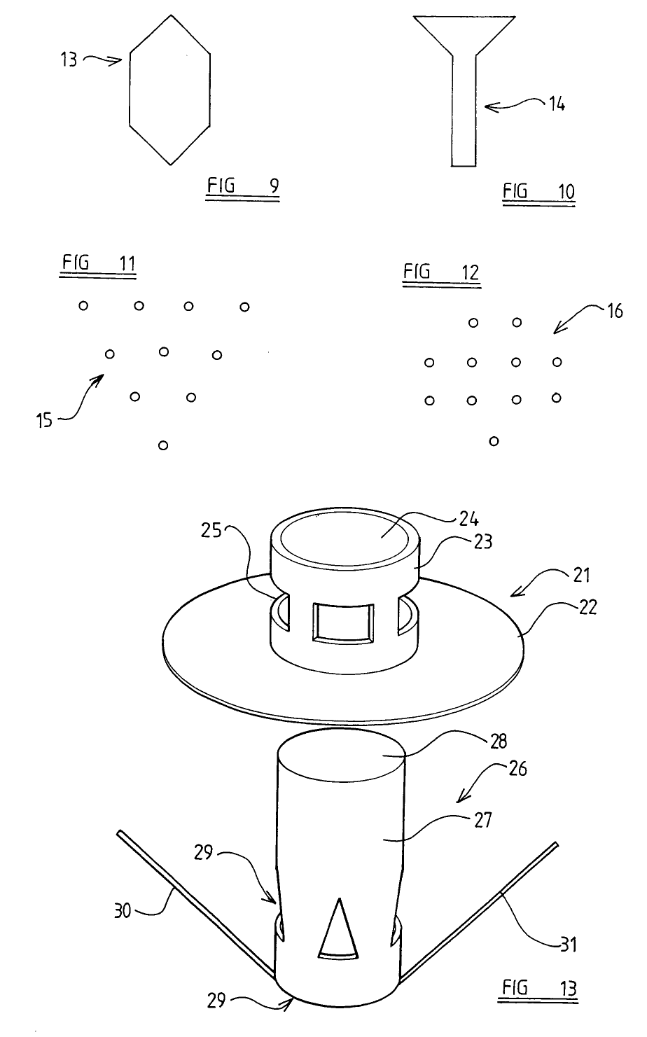

FIG. 11 illustrates a group of apertures that may be used in one embodiment of the invention,

FIG. 12 illustrates a further group of apertures that may be used in an embodiment of the invention,

FIG. 13 is an exploded view of components which can be combined to form a further embodiment of the invention,

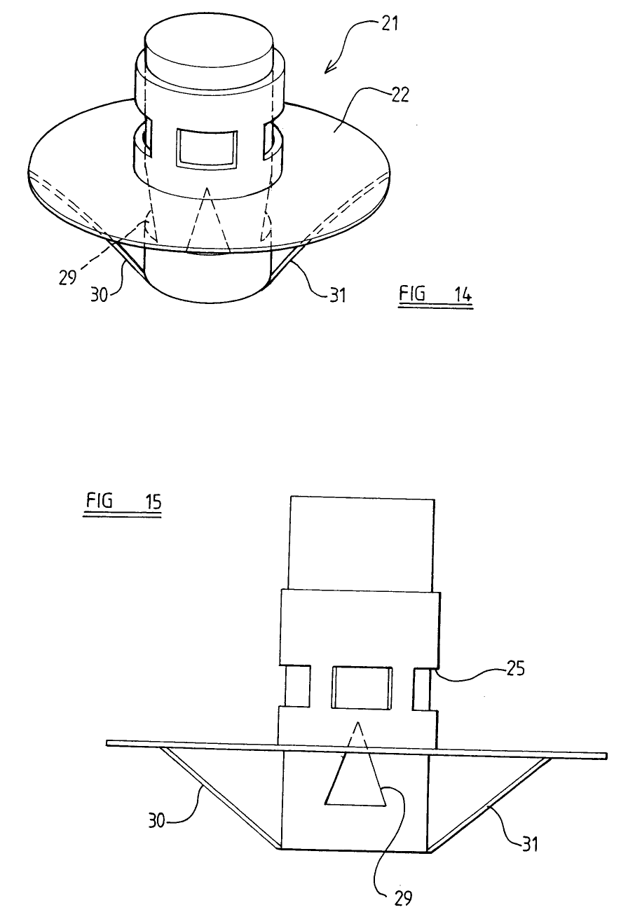

FIG. 14 is a perspective view of the components of FIG. 13 when combined and in a first relative position,

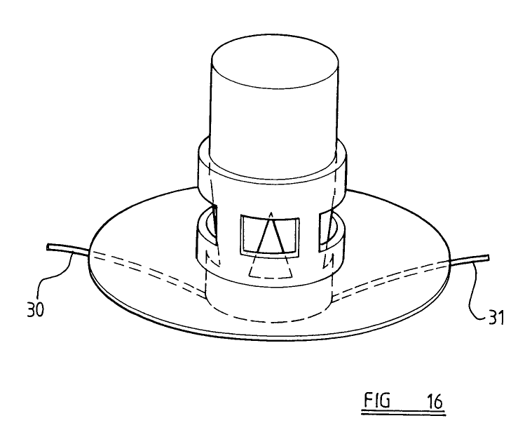

FIG. 15 is a side view of the assembled valve unit of FIG. 14, and

FIG. 16 is a view corresponding to FIG. 14 illustrating the components of the valve unit in a further relative position.

Referring initially to FIG. 1, a valve unit for use with an air-bag comprises a first fixed component 1 which is intended to be fixed to part of the air-bag or part of the gas generator housing of the air-bag. The fixed component 1 comprises a mount in the form of an annular mounting flange 2, from the centre of which a tubular housing 3 extends upwardly, the housing 3 having an open top 4. A cylindrical passage is defined which extends right through the housing 3. A generally rectangular aperture 5 is formed in the side-wall of the housing 3. The main axis of the rectangular aperture extends generally parallel with the plane defined by the flange 2.

A movable component 6 is provided which is configured to be in sliding engagement with the fixed component 1. The movable component 6 comprises a lower circular flange 7, and a closed cylindrical housing 8 extends upwardly from the flange 7, the upper end 9 of the housing 8 being closed. The interior of the housing 8 is hollow, and the lower end of the housing 8 is aligned with an aperture 10 formed in the circular flange 7.

An aperture in the form of a rectangular window 11 is formed in the side-wall of the cylindrical housing 8, the principal axis of the window 11 extending vertically, that is to say substantially perpendicularly to the plane defined by the flange 7.

A helical compression spring 12 is also provided and is dimensioned to surround the cylindrical housing 8 and the rest on the circular flange 7.

The cylindrical housing 8 is dimensioned to be a sliding and substantially sealing fit within the tubular housing 3.

The components of FIG. 1 are assembled by initially mounting the helical compression spring 12 in position over the cylindrical housing 8 so as to rest on the flange 7 surrounding the cylindrical housing 8 and then inserting the cylindrical housing 8 upwardly into the tubular housing 3 of the fixed component 1, so that the closed upper end 9 of the cylindrical housing 8 of the movable component 6 extends upwardly through the open top 4 of the tubular housing 3 of the fixed component 1. The helical compression spring 12 thus becomes trapped between the lower flange 7 on the movable element 6 and the mounting flange 2 provided on the fixed component 1.

In an initial condition of the fixed component 1 and the movable component 6, the aperture 5 and the window 11 are off-set as illustrated in FIG. 2. The valve is thus substantially sealed as no gas can flow through the valve.

Here it is to be understood that the valve will be mounted in position by means of the mounting flange 2, with the open end 4 of the tubular housing 3 being directed outwardly away from the entire air-bag, so that the open end communicates with atmosphere. The movable component 6 is mounted in position so that the lower flange 7 of the movable component 6 is located within the air-bag or within the gas generator housing of the air-bag so that the movable component is exposed to pressure from the gas within the air-bag.

On inflation of the air-bag, high pressure gas will act on the flange 7 and the closed end 9 of the cylindrical housing 8 of the movable component 6, tending to move the flange 7 of the movable component 6 towards the mounting flange 2 of the fixed component 1, with this movement being resisted by the compression spring 12. During the initial part of this movement, the aperture 5 and the window 11 remain off-set, and so the valve retains closed and no gas can escape from the air-bag or the gas generator housing for the air-bag.

However, should the pressure within the air-bag reach a predetermined threshold, the effect of the gas on the movable component 6 will be such that the spring 12 is compressed sufficiently to enable the window 11 to at least partially overlap the aperture 5. A flow path is thus created extending from the interior of the air-bag, or the interior of the gas generator housing, to the free atmosphere, thus providing a vent path for gasses within the air-bag.

The size of the vent path will depend upon the pressure of the gas since, as the pressure continues to rise, so the movable element 6 will be moved further, in the same direction as described above, and thus a substantial area of the window 11 in the movable component 6 will become aligned with the aperture 5 within the fixed component 1, until an optimum size vent path is created. FIG. 3 shows the components of the valve of FIGS. 1 and 2 in such a position, and here it can be seen that the flange 7 of the movable component 6 is extremely close to the mounting flange 2 of the fixed component 1.

Referring to FIG. 4, a movable component 6′ is shown, which is generally similar to the movable component 6 as shown in FIG. 1, save that the window 11 is not rectangular, but is, instead of triangular form.

It is to be understood that the component 6′ shown in FIG. 4 is to be mounted within a fixed component 1 precisely as shown in FIG. 1.

FIG. 5 is schematic view showing the initial position of the triangular window 11′ in the movable component 6′ relative to the rectangular aperture 5 (shown in phantom) of the fixed component 1. It can be seen that in this position of the components there is no overlap between the window 11′ and the aperture 5 at all, and thus there is no vent flow path created.

FIG. 6 shows the situation that exists when the movable component 6′ has moved slightly relative to the fixed component 1 under the pressure of gas within the air-bag. Part of the triangular window 11′ is now superimposed over the fixed aperture 5, thus creating a vent flow path with a predetermined cross-section.

Turning now to FIG. 7 it will be understood that when the movable component 6′ has effected a further movement, the lower-most part of the triangular window 11′ becomes co-aligned with the rectangular aperture 5 of the fixed component 1, thus providing a vent flow path of maximum dimension.

Here it is to be understood that the effective size of the vent flow path depends upon the distance by which the movable component 6 or 6′ has moved relative to the fixed component 1, and the degree of movement is controlled by the pressure existing within the air-bag or within the gas generator. Thus, for a higher pressure of gas, a larger size vent aperture is provided.

This may prove to be very advantageous since, when a relatively light seat occupant hits an air-bag during an accident situation, the pressure increase within the bag will not be as great as the pressure increase that occurs when a very heavy occupant hits the air-bag. In the case of a light occupant it is not desirable to provide as much venting to the air-bag as in the case of a heavy occupant. It is thus to be understood that an arrangement of the type shown in FIGS. 4 to 7 may provide a very desirable characteristic because the degree of venting can be automatically selected in dependence upon the parameters of the accident that caused inflation of the air-bag and/or in dependence upon parameters such as the weight of the seat occupant.

FIG. 8 illustrates a further movable component 6″, which again corresponds with the movable component 6 of FIG. 1, save that the window aperture 11″ is this time on an inverted triangular form. Here it is to be understood that in use of a valve incorporating the movable component 6″ of FIG. 8, the valve will initially provide a sealing effect, and then after a predetermined pressure rise will provide a relatively large cross-sectional area vent flow path, but with further increases of pressure the cross-sectional area of the vent flow path will reduce. This arrangement is considered particularly advantageous for protecting unbelted occupants in the event of a crash, because a heavy unbelted occupant could strike through a normally-vented air-bag if the vent were not reduced during the impact.

It is possible to use many different shaped window apertures in a movable element equivalent to the movable element 6 of FIG. 1, 6′ of FIG. 4 or 6″ of FIG. 8. For example, FIG. 9 illustrates a generally hexagonal window aperture 13 which may be used in one embodiment of the invention.

FIG. 10 illustrates a further window aperture 14 which has a relatively narrow lower part of uniform cross-section and an upper terminal triangular part of upwardly increasing cross-section.

Instead of using a single window aperture in the movable component 6 it is possible to use a group of apertures, such as the group of apertures 15 shown in FIG. 11. The group of apertures 15 forms a generally triangular pattern. Alternatively, a group of apertures may form a non-triangular pattern, such as the group of apertures 16 shown, by way of example, in FIG. 12.

It will be understood that with each particular form of window aperture or apertures, a different venting effect will be provided. It is envisaged that it will be possible to select a venting effect for many different types of air-bag simply by adjusting the size and/or shape and/or position of the window aperture or apertures.

Whilst the invention has been described so far with reference to embodiments in which the fixed component is provided with a rectangular aperture, and the movable component may be provided with window apertures selected from many possibilities, it is to be understood that the movable component may have a rectangular aperture with the fixed component having an aperture selected from a number of different shapes and sizes. Indeed it is possible for both the fixed component and the movable component to have a plurality of apertures.

Whilst, in the embodiments described above, the movable component 6, 6′, 6″ moves against a resistive force provided by a helical compression spring 12, in a further embodiment of the invention, a fixed component may be associated with a movable component, the movable component being held in an initial position by a deformable or frangible element. Turning now to FIG. 13, the components of a valve of this type are illustrated.

A fixed component 21 is provided, the fixed component 21 having an annular mounting flange 22. A tubular housing 23 extends upwardly from the central part of the flange 22, the tubular housing 23 having an open upper end 24. A passage or bore extends right through the tubular housing 23 extending from the lower face of the flange 22. A plurality of rectangular apertures 25 are provided formed in the side-wall of the tubular housing 23, so as to be arranged around its circumference.

A movable component 26 is also provided, the movable component 26 comprising a generally cylindrical hollow housing 27 having a closed upper end 28 and having an open lower end 29. Formed in the side-wall of the cylindrical housing 27 are a plurality of triangular window apertures 29.

Extending outwardly and upwardly from the open lower end of the cylindrical housing 27 are two yieldable arms 30, 31 which may be formed, for example, of an appropriate plastics material.

It is envisaged that the cylindrical housing 27 of the movable component 26 may be inserted upwardly through the bore passing through the tubular housing 23 of the fixed component 21. The cylindrical housing 27 is designed to be a sliding and substantially sealing fit within the tubular housing 23.

The cylindrical housing 27 of the movable component 26 may move upwardly until the arms 30, 31 engage the under-surface of the mounting flange 22 of the fixed component 21. This is the position shown in FIGS. 14 and 15. With the components in this position, the triangular window apertures 29 are totally off-set from the rectangular apertures 25 present in the fixed component 21 and thus the valve is sealed. Should the valve be subjected to high pressure gas, the gas will tend to cause the movable component 26 to move upwardly, when the valve is in the orientation shown in FIGS. 13 to 15. This will cause the deformable arms 30, 31 to deform, and the movable component 26 may move upwardly until the triangular window apertures 29 are co-aligned with the rectangular apertures 25, as shown in FIG. 16. A continuing upward force applied to the movable component 26 by the pressurised gas will cause the deformable arms 30, 31 to deform to a greater extent, thus enabling a greater cross-sectional area of each triangular window aperture 29 to be aligned with the corresponding rectangular aperture 25, consequently increasing the cross-sectional area of the vent path thus created.

Of course it is to be understood that whilst the embodiment of FIGS. 13 to 16 has a plurality of rectangular apertures formed in the fixed component 21 and a plurality of triangular apertures formed in the movable component 26, alternative forms of apertures may be used in each component.

In the embodiment of FIGS. 13 to 16 the deformable arms 30, 31 deform, effectively absorbing some energy as the component is moved. This provides a regulating effect, so that the cross-sectional area of the vent passage that is created is dependent upon the pressure of gas within the air-bag or within the gas generator housing.

The invention has been described above primarily with reference to embodiments in which the movable component is moved solely in dependence upon pressure applied to the movable component within the air-bag. It is envisaged, however, that the movable component may be moved in response to other parameters, such as parameters relating to the speed of the vehicle before an accident, or a parameter relating to the weight of a seat occupant. In such an embodiment of the invention a mechanism will be provided to move the movable component relative to the fixed component. In such an arrangement both the movable component and the fixed component may be substantially flat rather than being cylindrical as shown in the accompanying drawings.

In the present Specification “comprises” means “includes or consists of” and “comprising” means “including or consisting of”.

The features disclosed in the foregoing description, or the following Claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A valve for an air-bag, the valve comprising a fixed component, the fixed component having a mount to mount the component to an air-bag or a gas generator housing, the fixed component defining at least one aperture, the valve incorporating a moveable component configured to be exposed to pressure from inflating gas within the air-bag, the moveable component also being configured to be slidably engaged with the fixed component and having at least one aperture formed therein, the components having an initial position in which the aperture in fixed component is totally off-set from the or each aperture in the movable component, and the movable component being movable relative to the fixed component, under the action of gas pressure within the air-bag, to a position in which at least part of the or each aperture formed in the movable component is co-aligned with the aperture in the fixed component thus creating a vent flow passage for gas from the interior of the air-bag or the gas generator housing.

2. A valve according to claim 1 when mounted on an air-bag or a gas generator housing.

3. A valve according to claim 1 wherein the fixed component comprises a tubular housing, the or each aperture of the fixed component being formed in a side-wall of the tubular housing.

4. A valve according to claim 3 wherein the tubular housing is provided with a flange at one end to act as said mount.

5. A valve according to claim 3 wherein the movable component comprises a cylindrical housing, the cylindrical housing being configured to be received as a sliding and substantially sealing fit within the tubular housing of the fixed component, there being an element to maintain the movable component in said initial position relative to the fixed component.

6. A valve according to claim 5 wherein the or each aperture of the movable component is formed within the side-wall of the cylindrical housing.

7. A valve according to claim 5 wherein the element to maintain the movable component in said initial position relative to the fixed component is a spring, the spring surrounding the cylindrical housing of the movable component and being engaged by a flange carried on the movable component and the mount of the fixed component.

8. A valve according to claim 5 wherein the movable component is provided with one or more deformable elements which engage part of the fixed component to hold the movable component in said initial position relative to the fixed component, the or each deformable element being configured to deform when gas pressure is applied to the movable component to permit the movable component to move relative to the fixed component.

9. A valve according to claim 1 wherein the fixed component has a single aperture.

10. A valve according to claim 1 wherein the fixed component has a plurality of apertures.

11. A valve according to claim 1 wherein the or each aperture of the movable component is of rectangular form.

12. A valve according to claim 1 wherein the or each aperture of the movable component is of triangular form.

13. A valve according to claim 1 wherein the or each aperture of the movable element is of irregular form.

14. A valve according to claim 1 wherein the movable component is moved relative to the fixed component in response to a signal representative of a parameter.

15. A valve according to claim 14 wherein the parameter relates to the weight of a seat occupant.

16. A valve according to claim 15 wherein the parameter relates to an indicator of accident severity.
